(19) United States
(12) Patent Application Publication
(10) Pub. No.: US 2025/0149989 A1
(43) Pub. Date: May 8, 2025

(54) FLYBACK POWER SUPPLY CIRCUIT AND INVERTER DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Takashi YAMADA, Nisshin-shi (JP)

(21) Appl. No.: 18/829,412

(22) Filed: Sep. 10, 2024

(30) Foreign Application Priority Data
Nov. 8, 2023 (JP) 2023-190853

(51) Int. Cl. H02M 3/335; H02M 7/5387

(52) U.S. Cl. CPC H02M 3/33523; H02M 7/5387

(57) ABSTRACT

In a flyback power supply circuit, electric power for driving semiconductor switching elements constituting a three-phase inverter circuit is generated by a plurality of transformers having primary windings and secondary windings. The primary windings of the multiple transformers are connected in series. The control unit controls a semiconductor switch that turns on and off the current flowing from the input power supply to the primary winding. A rectifier circuit is connected to each secondary winding.

### CROSS REFERENCE TO RELATED APPLICATION

The present application claims the benefit of priority from Japanese Patent Application No. 2023-190853 filed on Nov. 8, 2023. The entire disclosure of the above application is incorporated herein by reference.

### TECHNICAL FIELD

The present disclosure relates to a flyback power supply circuit that generates electric power for driving each semiconductor switching element constituting a three-phase inverter, and to an inverter device including the flyback power supply circuit.

### BACKGROUND

For example, a conceivable technique teaches a flyback power supply that uses six or three transformers to generate electric power for driving each semiconductor switching element that constitutes a three-phase inverter, and connects the primary windings of these transformers in parallel.

### SUMMARY

According to an example, in a flyback power supply circuit, electric power for driving semiconductor switching elements constituting a three-phase inverter circuit is generated by a plurality of transformers having primary windings and secondary windings. The primary windings of the multiple transformers are connected in series. The control unit controls a semiconductor switch that turns on and off the current flowing from the input power supply to the primary winding. A rectifier circuit is connected to each secondary winding.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing the configuration of a flyback power supply circuit in a first embodiment;

FIG. 2 is a diagram showing a configuration of a flyback power supply circuit in a second embodiment;

FIG. 3 is a diagram showing a configuration of a flyback power supply circuit in a third embodiment;

FIG. 4 is a diagram showing the variation of the load current and the variation of the output voltage in the flyback power supply circuit of the first embodiment;

FIG. 5 is a diagram showing the variation of the load current and the variation of the output voltage in the flyback power supply circuit of the second and third embodiments;

FIG. 6 is a diagram showing a model circuit for explaining the effects of the second and third embodiments;

FIG. 7 is a diagram showing voltage and current waveforms on the primary and secondary sides of a transformer with respect to variations in load current when a feature in the first embodiment is applied to the circuit shown in FIG. 6;

FIG. 8 is a diagram showing voltage and current waveforms on the primary and secondary sides of a transformer in response to variations in load current in the circuit shown in FIG. 6;

FIG. 9 is a diagram showing a configuration of a flyback power supply circuit in a fourth embodiment;

FIG. 10 is a diagram showing a configuration of a flyback power supply circuit in a fifth embodiment;

FIG. 11 is a diagram showing a configuration of a flyback power supply circuit in a sixth embodiment; and

FIG. 12 is a diagram showing the layout of wiring between six transformers on a circuit board when the flyback power supply circuit of the first to fourth embodiments is applied to an inverter device in a seventh embodiment.

### DETAILED DESCRIPTION

When the primary windings of a plurality of transformers are connected in parallel, it may be necessary to increase the size of each switching element since the current flowing through the switching elements increases by a factor of several times due to the parallel connection.

The present embodiments have been made in consideration of the above circumstances, and an object of the present embodiments is to provide a flyback power supply circuit that can reduce the size of multiple transformers and the size of switching elements for controlling the current flowing through the primary windings of these transformers, and an inverter device including the flyback power supply circuit.

According to the flyback power supply circuit of feature 1, electric power for driving six semiconductor switching elements constituting a three-phase inverter circuit is generated by a plurality of transformers having primary windings and secondary windings. The primary windings of the multiple transformers are connected in series. The control unit controls a semiconductor switch that turns on and off the current flowing from the input power supply to the primary winding.

In this way, by connecting the primary windings of multiple transformers in series, the inductance per transformer is reduced, and the size of the transformer can also be reduced. Furthermore, since the current flowing through the switching element via the primary winding is also reduced, the size of the switching element can also be reduced.

According to the flyback power supply circuit according to feature 2, a transformer having a plurality of auxiliary windings is used, one end of each auxiliary winding is commonly connected to ground, and input terminals of a plurality of rectifier elements are connected to the other end of each auxiliary winding. A capacitor has one end connected to the output terminals of the multiple rectifier elements and the other end connected to the ground. With this configuration, when the current flowing through the secondary winding of the transformer increases, the current flowing through the auxiliary winding decreases accordingly. Therefore, even if there is a variation in the current flowing through the load, the variation in each output voltage can be suppressed.

According to the flyback power supply circuit according to feature 3, a transformer having a plurality of auxiliary windings is used, one end of each auxiliary winding is commonly connected to ground, and an input terminal of a rectifier element is connected to the other end of each auxiliary winding. A capacitor has one end connected to the output terminal of the rectifier element and the other end connected to the ground. With this configuration, the number of rectifying elements can be reduced more than in the feature 2.

An inverter device according to feature 8 includes a three-phase inverter circuit and a flyback power supply circuit according to any one of the first to third features, and the number of transformers is six. When the three phases are defined as U-phase, V-phase, and W-phase, the connection order of the primary windings of each transformer on the circuit board on which the three-phase inverter circuit is mounted is an order of the input power supply, an U-phase upper arm, a V-phase upper arm, a W-phase upper arm, a W-phase lower arm, a V-phase lower arm, an U-phase lower arm, and a semiconductor switch.

### First Embodiment

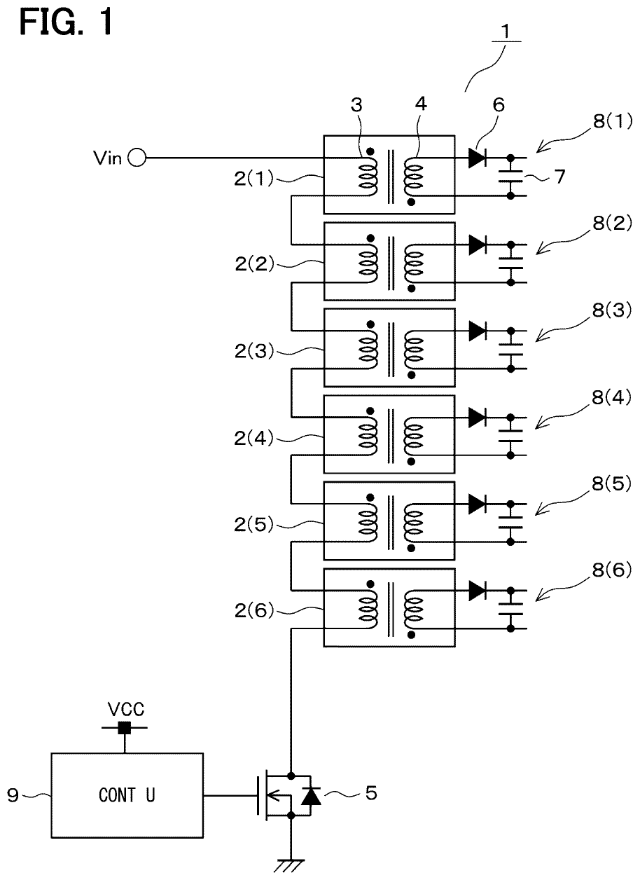

As shown in FIG. 1, a flyback power supply circuit 1 of the present embodiment is applied to an inverter circuit configured by connecting six power semiconductor switching elements, such as power MOSFETs or IGBTs, in a three-phase bridge connection, and generates an electric power for driving the gates of each semiconductor switching element. For this reason, the flyback power supply circuit 1 uses six transformers 2(1) to 2(6). Each transformer 2 includes a primary winding 3 and a secondary winding 4.

A series circuit of primary windings 3(1) to 3(6) of six transformers 2(1) to 2(6) and a semiconductor switch, for example an N-channel MOSFET 5, is connected between an input power supply Vin and ground. A rectifier circuit 8 including a series circuit of a diode 6 and a capacitor 7 is connected between each of the secondary windings 4(1) to 4(6). A DC voltage is output from both ends of the capacitor 7. This output voltage is supplied as a driving power supply to a driving circuit that drives the gates of the semiconductor switching elements for constituting the inverter circuit.

The gate of the MOSFET 5 is driven by the control unit 9. The control unit 9 monitors one of the output voltages and controls the MOSFET 5 to turn on and off so that the output voltage becomes a predetermined voltage. The control unit 9 is supplied with a control voltage VCC for operation. For example, the input voltage is about 100 V to 1000 V, the control voltage VCC is about 10 V to 20 V, and the output voltage of the flyback power supply circuit 1 is about 20 V to 30 V.

The flyback power supply circuit 1 of this embodiment configured as above provides the following effects. By connecting the primary windings 3(1) to 3(6) of the six transformers 2(1) to 2(6) in series, the inductance of each transformer 2 is reduced, so that the size of the transformer 2 is minimized. Furthermore, the current flowing through the primary winding 3 is smaller than that in the configuration in which the primary windings of a plurality of transformers are connected in parallel as in the conceivable technique. Therefore, the size of the MOSFET 5 can also be reduced.

### Second Embodiment

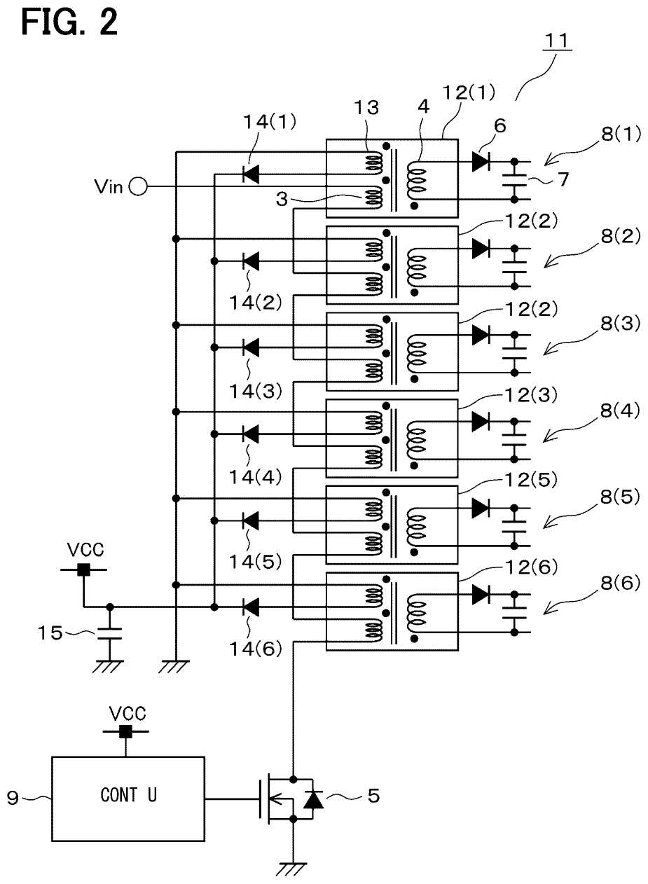

Hereinafter, the identical parts as those in the first embodiment will be designated by the same reference numerals for simplification of the description. Only differences from the first embodiment will be described below. As shown in FIG. 2, a flyback power supply circuit 11 of the second embodiment uses transformers 12(1) to 12(6) instead of the transformers 2(1) to 2(6). The transformer 12 includes an auxiliary winding 13 in addition to the primary winding 3 and the secondary winding 4. One end of each of the auxiliary windings 13(1) to 13(6) is commonly connected to the ground, and the other end is connected to the input terminal, that is the anode, of a diode 14(1) to 14(6) which is a rectifier element, respectively. The output terminals (i.e., cathodes) of the diodes 14(1) to 14(6) are connected to a common connection point between the control power supply VCC and one end of the capacitor 15. The other end of the capacitor 15 is connected to the ground.

Here, the number of turns of the primary winding 3 is defined as Np, the number of turns of the secondary winding 4 is defined as Ns, and the number of turns of the auxiliary winding 13 is defined as Naux. It may be preferable to set them to satisfy the expression of “Np, Ns>Naux”. This allows the size of the transformer 12 to be made smaller.

According to the second embodiment configured as above, even if the load current varies, the variation in the output voltage can be suppressed, and this effect will be described in the third embodiment.

### Third Embodiment

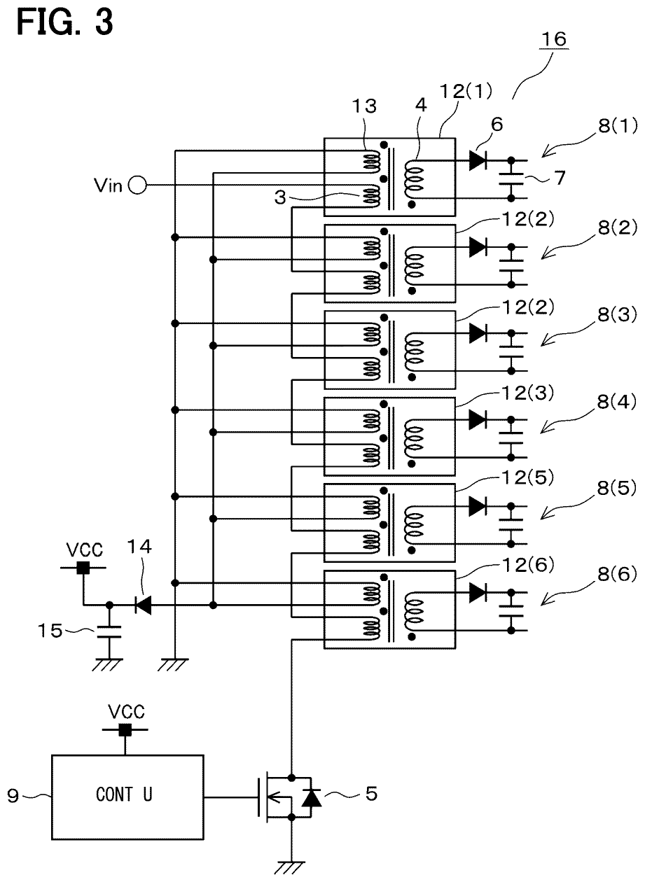

As shown in FIG. 3, a flyback power supply circuit 16 of the third embodiment uses only one diode 14, and the other end of each of the auxiliary windings 13(1) to 13(6) is commonly connected to the anode of the diode 14. According to this configuration, the number of diodes 14 can be reduced compared to the flyback power supply circuit 11 of the second embodiment.

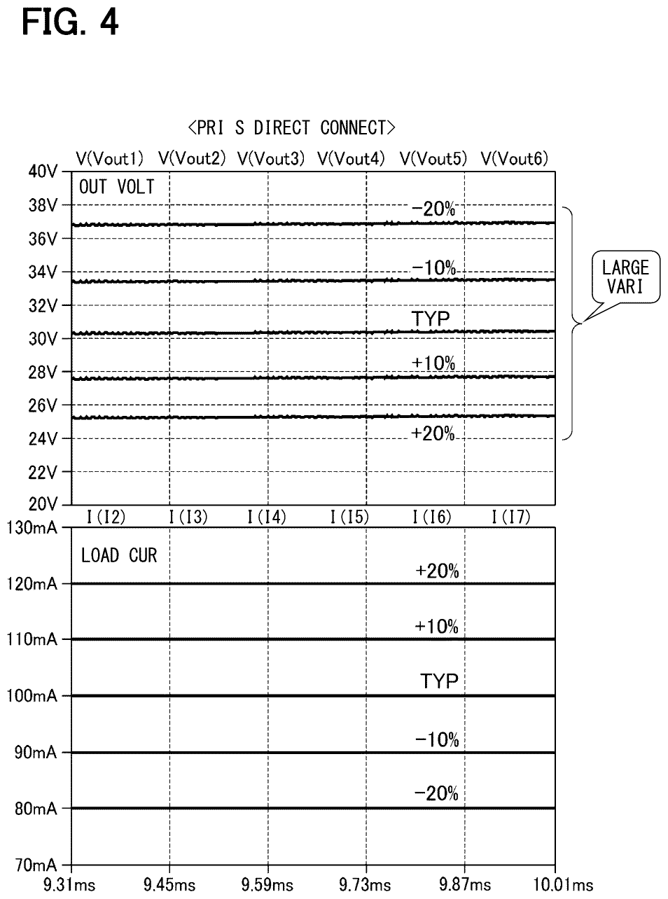

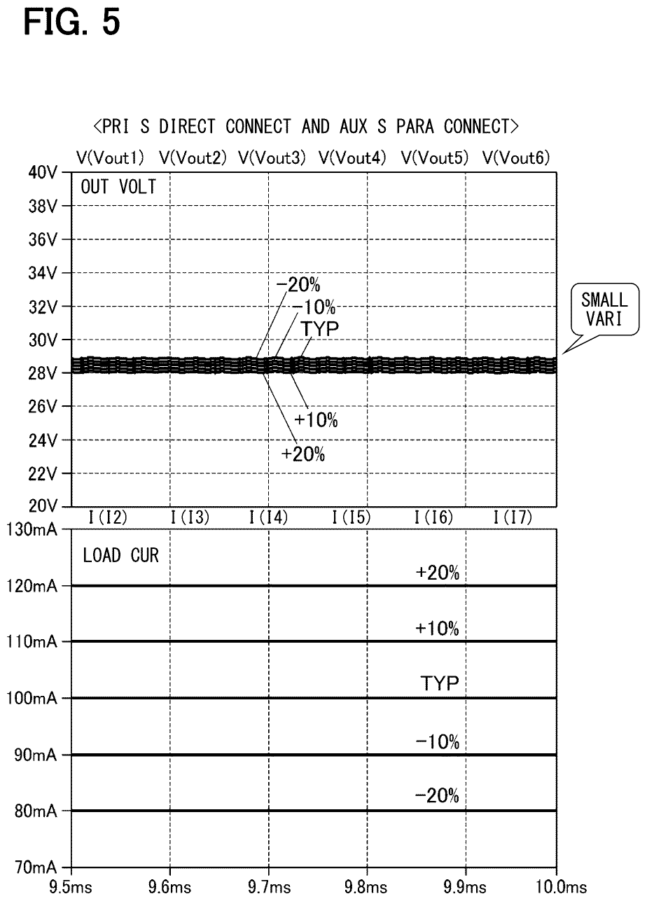

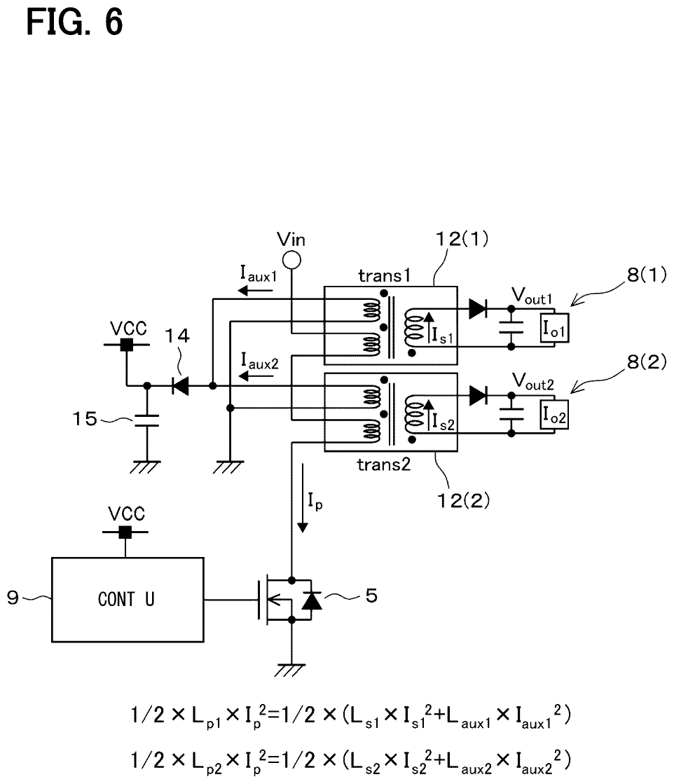

The following describes the operation of each of the second and third embodiments. As shown in FIG. 4, in the flyback power supply circuit 1 of the first embodiment, when the current flowing through the load varies, the output voltage also varies accordingly. In contrast, as shown in FIG. 5, in the flyback power supply circuits 11 and 16 of the second and third embodiments, even if the load current varies, the variation in the output voltage is not almost generated. This principle will be explained using a model using two transformers 12(1) and 12(2) shown in FIG. 6.

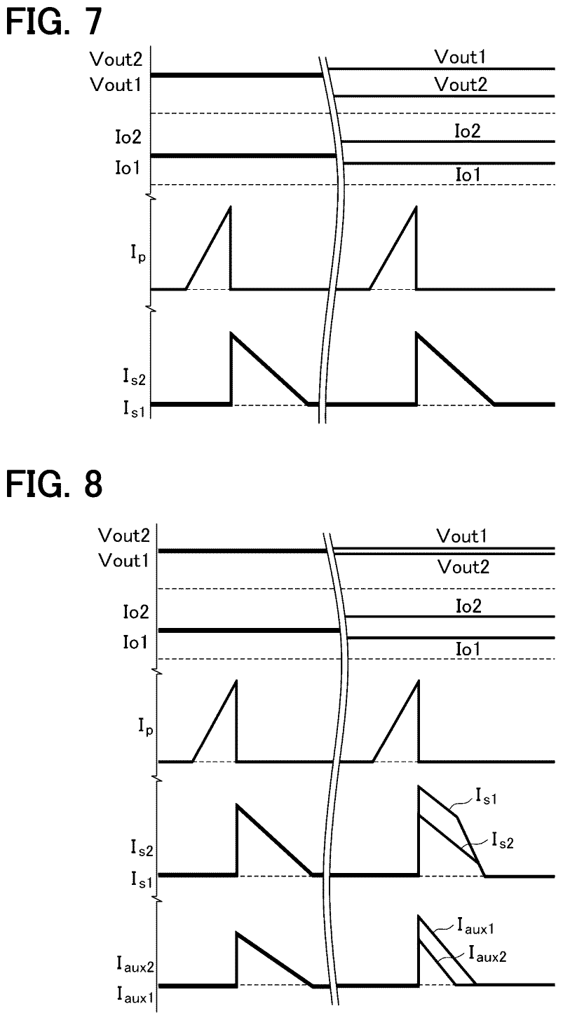

In the above model, a configuration in which the primary windings 3(1) and 3(2) are simply connected in series as in the first embodiment is assumed. In this case, the electric power supplied to the primary windings 3(1) and 3(2) is the same, and the energy transferred to the secondary side is also the same. Therefore, as shown in FIG. 7, when the load currents Io1 and Io2 vary, the output voltages Vout1 and Vout2 also vary. In the example shown in FIG. 7, when an expression of “Io1<Io2” is set, the expression of “Vout1 >Vout2” is satisfied.

In contrast to this, when the auxiliary windings 13(1) and 13(2) are provided as in the second embodiment, the energy excited on the primary side is distributed to the secondary winding 4 and the auxiliary winding 13. Therefore, as shown in FIG. 8, when the load current Io2 becomes larger, the current Is2 flowing through the secondary winding 4(2) becomes larger than the current Is1. Accordingly, the current Iaux2 flowing through the auxiliary winding 13(2) becomes smaller than the current Iaux1. As a result, the variation in the output voltage Vout2 is suppressed.

In the conceivable technique, the primary windings are connected in parallel on the assumption that there is little variation in the load connected to the secondary side of the transformer. Therefore, when there is variation in the load on the secondary side, the output voltage on the secondary side of the flyback power supply will vary. Furthermore, although the conceivable technique describes feedback control of any one of the secondary side output voltages, in order to suppress variations, feedback control must be performed on all three phases.

In contrast, according to the second and third embodiments, a transformer 12 having an auxiliary winding 13 is used, and the primary windings 3 are connected in series. One end of each auxiliary winding 13 is connected to the ground, and the other end is connected in parallel via the diodes 14(1) to 14(6) or is commonly connected to the anode of one diode 14, thereby making it possible to suppress variations in the output voltage. In this case, the control unit 9 may perform feedback control by monitoring the terminal voltage of the capacitor 15.

### Fourth Embodiment

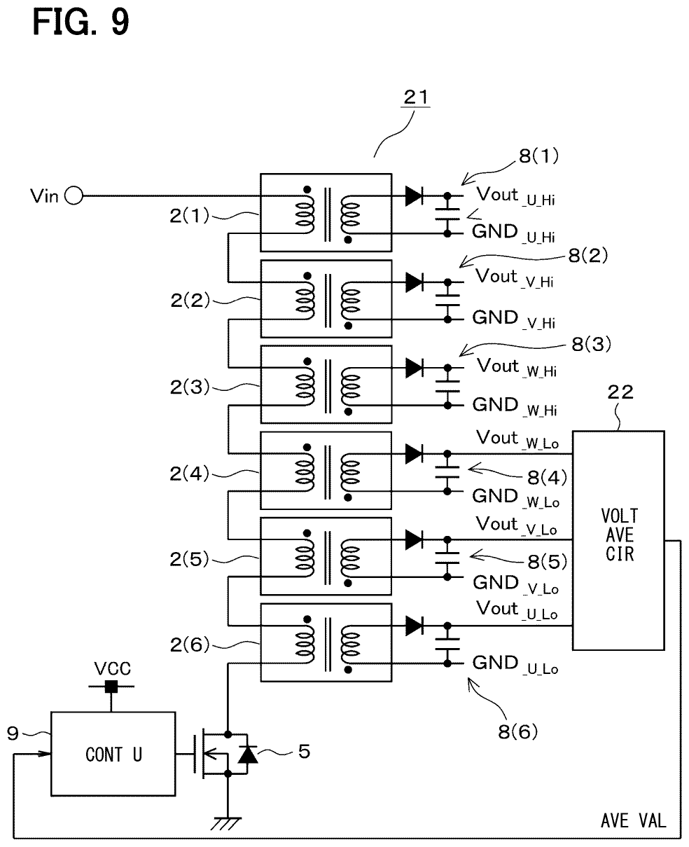

As shown in FIG. 9, a flyback power supply circuit 21 of the fourth embodiment has a configuration in which a voltage averaging circuit 22 is added to the flyback power supply circuit 1 of the first embodiment. The output voltages from the rectifier circuits 8(4) to 8(6) are input to the voltage averaging circuit 22. When the three phases are defined as a U phase, a V phase, and a W phase, respectively, and the output voltages from each rectifier circuit 8(1) to 8(6) are defined as upper arm power supplies for the U to W phases and lower arm power supplies for the U to W phases, respectively, as shown in FIG. 9, the voltages of the lower arm power supplies for the U to W phases are input to the voltage averaging circuit 22.

In the voltage averaging circuit 22, for example, the input three-phase voltages are averaged by applying them to a common capacitor via resistor elements, and the control unit 9 controls the MOSFET 5 to turn on and off based on the average voltage. According to the fourth embodiment configured as described above, the control unit 9 controls the switching of the MOSFET 5 based on the three-phase voltages averaged by the voltage averaging circuit 22, so that the variation in the output voltage of the flyback power supply circuit 21 can be further suppressed.

### Fifth Embodiment

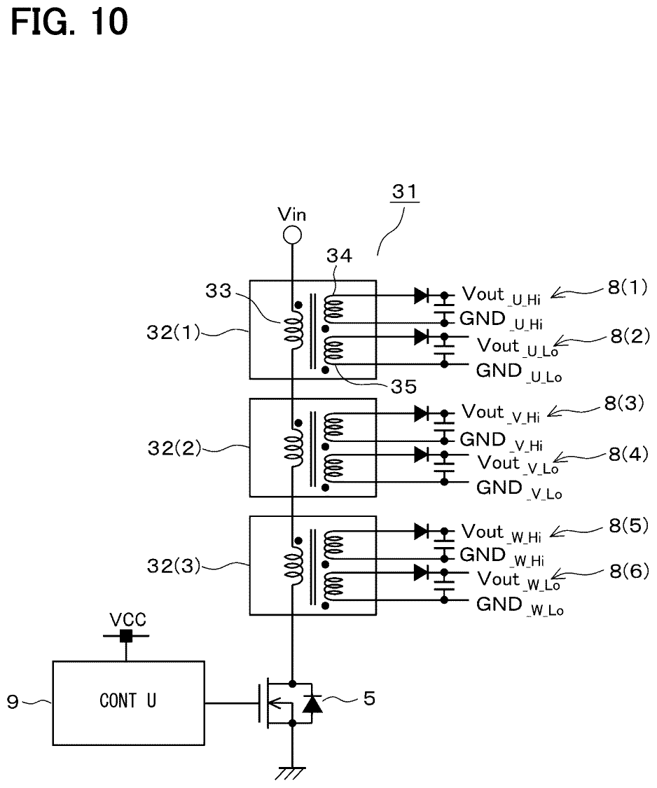

As shown in FIG. 10, a flyback power supply circuit 31 of the fifth embodiment uses three transformers 32(1) to 32(3). Each transformer 32 includes a primary winding 33 and two secondary windings 34 and 35. The three primary windings 33(1) to 33(3) are connected in series as in each embodiment. The rectifier circuits 8(1) to 8(6) are connected to the secondary windings 34(1) to 34(3) and 35 (1) to 35 (3) of the transformers 32(1) to 32(3), respectively. The output voltages of the rectifier circuits 8(1) to 8(6) are allocated to the U-to W-phase upper arm power supplies and the U-to W-phase lower arm power supplies, as in the fourth embodiment.

According to the fifth embodiment configured as described above, six driving power supplies can be generated using the three transformers 32(1) to 32(3), so that the number of transformers used can be reduced.

### Sixth Embodiment

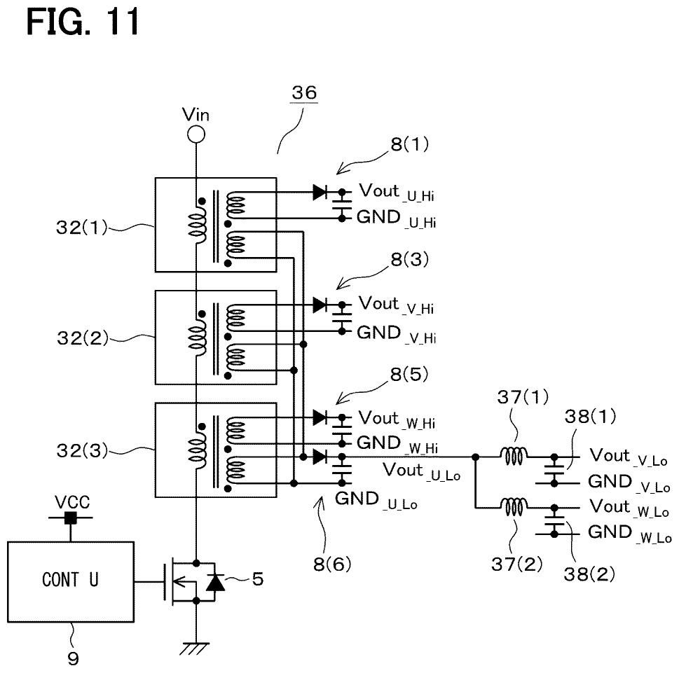

As shown in FIG. 11, the flyback power supply circuit 36 of the sixth embodiment uses three transformers 32(1) to 32(3) similar to the flyback power supply circuit 31 of the fifth embodiment, but the secondary windings 35 (1) to 35 (3) are connected in parallel to the rectifier circuit 8(6). The rectifier circuits 8(2) and 8(4) are omitted. A series circuit of a coil 37 (1) and a capacitor 38(1), and a series circuit of a coil 37 (2) and a capacitor 38(2) are connected in parallel to the anode of the diode 6 that constitutes the rectifier circuit 8(6). The output voltage from rectifier circuit 8(6) is supplied as the power supply for the U-phase lower arm, and the output voltages from the capacitors 38(1) and 38(2) are supplied as the power supplies for the V- and W-phase lower arms, respectively.

According to the sixth embodiment configured as described above, the secondary windings 35 (1) to 35 (3) of the transformers 32(1) to 32(3) are connected in parallel to the rectifier circuit 8(6) and the electric power for the U-, V-, and W-phase lower arms is branched off from them to supply the electric power, thereby making it possible to further reduce the number of parts.

### Seventh Embodiment

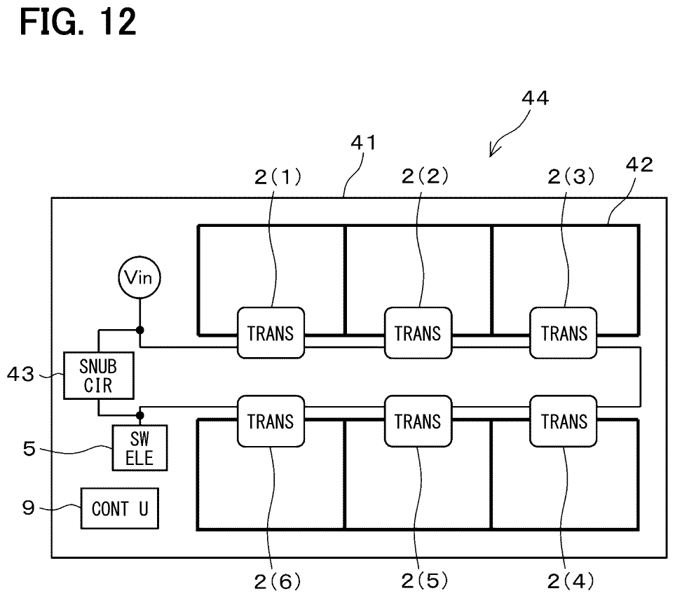

In the seventh embodiment, any one of the flyback power supply circuits 1, 11, 16, and 21 using six transformers 2 or 12 as in the first to fourth embodiments is applied to an inverter device. As shown in FIG. 12, six semiconductor switching elements are mounted on a circuit board 41 to form an inverter circuit 42. The six frames shown in FIG. 12 indicate the areas in which the semiconductor switching elements are mounted, and correspond to the U-to W-phase upper arms and the U-to W-phase lower arms, respectively.

For example, in the case of a flyback power supply circuit 1, the primary windings 3(1) to 3(6) of six transformers 2(1) to 2(6) are connected linearly from left to right on the upper arm side in the order of “U, V and W” in accordance with the arrangement of the six semiconductor switching elements between the input power supply Vin located at the upper left in FIG. 12 and the SW element and the MOSFET 5 located at the lower left in FIG. 12. When the W-phase upper arm is folded back to the lower arm side, the lower arm side is connected linearly from right to left in the order of “W, V and U”. In addition, a snubber circuit 43 is connected between the input power supply Vin and the MOSFET 5. The inverter device 44 is configured as described above.

According to the seventh embodiment configured as described above, when the flyback power supply circuit 1 and the like are mounted on the circuit board 41 constituting the inverter device 44, the wiring connecting the primary windings 3(1) to 3(6) of the six transformers 2(1) to 2(6) in series can be routed as short as possible. The present embodiments also includes the following features.

### Feature [1]:

A flyback power supply circuit generates a power supply to drive six semiconductor switching elements constituting a three-phase inverter circuit. The flyback power supply circuit includes: a plurality of transformers each having a primary winding and a secondary winding; a semiconductor switch that turns on and off a current flowing from an input power supply to the primary winding; a control unit that includes at least one of (i) a circuit and (ii) a processor having a memory storing computer program code; and a rectifier circuit connected to the secondary winding. The at least one of the circuit and the processor having the memory is configured to cause the control unit to control an on operation and an off operation of the semiconductor switch. A plurality of primary windings of the plurality of the transformers are connected in series.

### Feature [2]:

In the flyback power supply circuit according to the feature 1, each of the plurality of the transformers further includes an auxiliary winding. One end of each auxiliary winding is commonly connected to ground. The flyback power supply circuit further includes: a plurality of rectifier elements each having an input terminal connected to an other end of a respective auxiliary winding; and a capacitor having one end connected to output terminals of the plurality of rectifier elements and an other end connected to the ground.

### Feature [3]:

In the flyback power supply circuit according to the feature 1 or 2, each of the plurality of the transformers further includes an auxiliary winding. One end of each auxiliary winding is commonly connected to ground. The flyback power supply circuit further includes: a rectifier element having an input terminal commonly connected to an other end of each auxiliary winding; and a capacitor having one end connected to an output terminal of the rectifier element and an other end connected to the ground.

### Feature [4]:

In the flyback power supply circuit according to the feature 2 or 3, a numerical number of turns of each auxiliary winding is set to be smaller than a numerical number of turns of the primary winding and the secondary winding.

### Feature [5]:

In the flyback power supply circuit according to any one of the features 1 to 4, a numerical number of the transformers is three, and each of the transformers has two secondary windings.

### Feature [6]:

In the flyback power supply circuit according to the feature 5, one of the secondary windings of each transformer is connected in parallel.

### Feature [7]:

In the flyback power supply circuit according to any one of the features 1 to 6, the control unit monitors output voltages for a plurality of phases and performs feedback control of turning on and of the semiconductor switch.

### Feature [8]:

An inverter device includes: the three-phase inverter circuit; and the flyback power supply circuit according to any one of the features 1 to 4. A numerical number of the transformers is three, and the three phases are defined as a U-phase, a V-phase, and a W-phase. A connection order of the primary windings of each of the transformers on a circuit board on which the three-phase inverter circuit is mounted is an order of an input power supply, a U-phase upper arm, a V-phase upper arm, a W-phase upper arm, a W-phase lower arm, a V-phase lower arm, a U-phase lower arm, and the semiconductor switch.

### OTHER EMBODIMENTS

The semiconductor switching elements may not be limited to power MOSFETs and IGBTs.

The semiconductor switching may not be limited to N-channel MOSFETs.

The relationship between the number of turns Np of the primary winding 3, the number of turns Ns of the secondary winding 4, and the number of turns Naux of the auxiliary winding 13 may not be necessarily set to be an expression of “Np, Ns>Naux”.

In the fourth embodiment, the number of transformers 2 for averaging the output voltages may be two or more. Alternatively, it is not always necessary to obtain the average of a plurality of output voltages.

The specific voltage values may be changed as appropriate depending on the individual design. The embodiments that can be combined can be implemented in appropriate combinations. Although the present disclosure has been described according to the embodiments, it is understood that the present disclosure is not limited to the above-described embodiments or structures. The present disclosure includes various modification examples and equivalents thereof. In addition, various combinations and forms, and further, other combinations and forms including only one element, or more or less than these elements are also within the sprit and the scope of the present disclosure.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a control unit to perform functions” should be understood that (i) only the circuit can cause a control unit to perform all the functions, (ii) only the processor can cause a control unit to perform all the functions, or (iii) the circuit can cause a control unit to perform at least one of the functions and the processor can cause a control unit to perform the remaining functions. For instance, in the case of the above-described (iii), function A and B among the functions A to C may be implemented by a circuit, while the remaining function C may be implemented by a processor.

What is claimed is:

1. A flyback power supply circuit for generating a power supply to drive six semiconductor switching elements constituting a three-phase inverter circuit, the flyback power supply circuit comprising:
a plurality of transformers each of which has a primary winding and a secondary winding;
a semiconductor switch that turns on and off a current flowing from an input power supply to each primary winding;
a control unit that controls an on operation and an off operation of the semiconductor switch; and
a rectifier circuit connected to each secondary winding, wherein:
a plurality of primary windings of the plurality of the transformers are connected in series.

2. The flyback power supply circuit according to claim 1, wherein:
each of the plurality of the transformers further includes an auxiliary winding; and
one end of each auxiliary winding is commonly connected to ground,
the flyback power supply circuit further comprising:
a plurality of rectifier elements each of which has an input terminal connected to an other end of a respective auxiliary winding; and
a capacitor having one end connected to output terminals of the plurality of rectifier elements and an other end connected to the ground.

3. The flyback power supply circuit according to claim 1, wherein:
each of the plurality of the transformers further includes an auxiliary winding; and
one end of each auxiliary winding is commonly connected to ground,
the flyback power supply circuit further comprising:
a rectifier element having an input terminal commonly connected to an other end of each auxiliary winding; and
a capacitor having one end connected to an output terminal of the rectifier element and an other end connected to the ground.

4. The flyback power supply circuit according to claim 2, wherein:
a numerical number of turns of each auxiliary winding is set to be smaller than a numerical number of turns of the primary winding and the secondary winding.

5. The flyback power supply circuit according to claim 1, wherein:
a numerical number of the transformers is three, and
each of the plurality of transformers further includes an other secondary winding.

6. The flyback power supply circuit according to claim 5, wherein:
one of the secondary winding and the other secondary winding of each transformer is connected in parallel.

7. The flyback power supply circuit according to claim 1, wherein:
the control unit monitors output voltages for a plurality of phases and performs feedback control of turning on and off the semiconductor switch.

8. The flyback power supply circuit according to claim 1, further comprising:
at least one of (i) a circuit and (ii) a processor having a memory storing computer program code, wherein:
the at least one of the circuit and the processor having the memory is configured to cause the control unit to control an on operation and an off operation of the semiconductor switch.

9. An inverter device comprising:
the flyback power supply circuit according to claim 1; and
the three-phase inverter circuit, wherein:
a numerical number of the transformers is three;
three phases are defined as a U-phase, a V-phase, and a W-phase; and
a connection order of the primary winding of each of the transformers on a circuit board on which the three-phase inverter circuit is mounted is an order of an input power supply, a U-phase upper arm, a V-phase upper arm, a W-phase upper arm, a W-phase lower arm, a V-phase lower arm, a U-phase lower arm, and the semiconductor switch.
